(19) United States
(12) Patent Application Publication
(10) Pub. No.: US 2022/0294141 A1
(43) Pub. Date: Sep. 15, 2022

(54) High-speed signal terminal, differential signal terminal pair and high-speed connector assembly

(71) Applicant: OUPIIN ELECTRONIC (KUNSHAN) CO., LTD., Kunshan City (CN)

(72) Inventor: Hsin Chih CHEN, Kunshan City (CN)

(21) Appl. No.: 17/317,911

(22) Filed: May 12, 2021

(30) Foreign Application Priority Data
Mar. 11, 2021 (CN) 202110265919.3
Mar. 11, 2021 (CN) 202120509640.0

(51) Int. Cl. H01R 13/05; H01R 13/24

(52) U.S. Cl. CPC H01R 13/057; H01R 13/2471

(57) ABSTRACT

The present invention discloses a high-speed signal terminal, a differential signal terminal pair and a high-speed connector assembly. The high-speed signal terminal comprises: a body portion, a U-shaped fork end, and a tail end. The differential signal terminal pair comprises a first differential signal terminal pair and a second differential signal terminal pair engaged in a criss-crossed manner, and the first differential signal terminal pair comprises two first high-speed signal terminals, and the second differential signal terminal pair comprises two second high-speed signal terminals. The high-speed connector assembly of the present invention adopts the differential signal terminal pair via a criss-crossed engaging type so that the high-speed connector assembly can be applied in a high-density and high-speed transmission environment and meet high-density and high-speed signal transmission requirement.

### TECHNICAL FIELD

The present invention relates to the technical field of connectors, and more particularly to a high-speed signal terminal, a differential signal terminal pair and a high-speed connector assembly, which can be used in a high-density, high-speed transmission environment and have good high-speed signal transmission performance.

### BACKGROUND

In recent years, the requirement for extremely large bandwidth in high-speed communications is increasing significantly. Bandwidth of 60 GHz can realize high-speed wireless communications by transmitting high-capacity and uncompressed data at a speed of several gigabytes per second. However, current high-speed connectors adopt traditional designs. For example, a male connector usually uses a straight-line male terminal, and a female connector uses an elastic female terminal. When the two are mated with each other, the straight-line design of the male terminal tends to leave stub. Especially, in high-speed operation, stub phenomenon will affect the transmission performance of a high-speed and high-frequency signal.

Therefore, it is necessary to provide a high-speed signal terminal and a high-speed connector assembly that can eliminate stub and maintain the highest frequency of the bandwidth to 60 GHz.

### SUMMARY OF THE INVENTION

The primary object of the present invention is to provide a high-speed signal terminal with a U-shaped fork structure which can facilitate engagement and shortening the engaging length so as to eliminate stub.

Other object of the present invention is to provide a differential signal terminal pair, including a first differential signal terminal pair and a second differential signal terminal pair. When the first and second differential signal terminal pairs are engaged with each other, the two can be mated in a criss-crossed manner (or in a quasi-star manner), so as to shorten the engaging length and eliminate stub.

Another object of the present invention is to provide a high-speed connector assembly, including a first high-speed connector and a second high-speed connector. When the first and second high-speed connectors are engaged with each other, the two can be mated in a criss-crossed structure (or in a quasi-star structure), so as to shorten the engaging length and eliminate stub, thereby maintaining the highest frequency of the bandwidth to 60 GHz.

Other objects and advantages of the present invention may be further understood from the technical features disclosed by the present invention.

To achieve the aforementioned objects, the present invention adopts the following technical solutions:

The present invention provides a high-speed signal terminal, comprising: a body portion, a U-shaped fork end and a tail end, wherein the body portion have two opposite wide surfaces and two opposite narrow edges; the U-shaped fork end is located at a front end of the body portion and is coplanar with the body portion; and the U-shaped fork end has two symmetrical and coplanar fork pieces, and a gap located between the two fork pieces; and the tail end is located at the rear end of the body portion.

In one embodiment, the body portion is plate-like and has a rectangular cross section.

In one embodiment, each of the fork pieces has a contact protrusion facing towards the gap.

In one embodiment, the tail end and the body portion are staggered, and the tail end is parallel to the U-shaped fork end and the body portion.

In one embodiment, the tail end is perpendicular to the U-shaped fork end and the body portion.

To achieve the aforementioned objects, the present invention also adopts the following technical solutions:

The present invention also provides a differential signal terminal pair, comprising a first differential signal terminal pair and a second differential signal terminal pair, and the first differential signal terminal pair comprising two first high-speed signal terminals, and the second differential signal terminal pair comprising two second high-speed signal terminals;

the two first high-speed signal terminals are edge-coupled, and each first high-speed signal terminal comprises: a first body portion, a first U-shaped fork end, and a first tail end; the first body portion has two opposite first wide surfaces and two opposite first narrow edges; the first U-shaped fork end is located at the front end of the first body portion and is coplanar with the first body portion, and the U-shaped fork end has two first fork pieces which are symmetrical and coplanar, and a first gap between the two first fork pieces; the first tail end is located at the rear end of the first body portion;

the two second high-speed signal terminals are wide-surface coupled, and each second high-speed signal terminal comprises: a second body portion, a second U-shaped fork end, and a second tail end; the second body portion has two opposite second wide surfaces and two opposite second narrow edges; and the second U-shaped fork end is located at a front end of the second body portion and is coplanar with the second body portion, and the two U-shaped fork ends have two second fork pieces which are symmetrical and coplanar, and a second gap between the two second fork pieces; and the second tail end is located at the rear end of the second body portion;

when the first differential signal terminal pair and the second differential signal terminal pair are mated, the first high-speed signal terminal and the corresponding second high-speed signal terminal are engaged in a criss-crossed manner, wherein the first body portion and the first U-shaped fork end are perpendicular to the second body portion and the second U-shaped fork end, the two first fork pieces clamp the two second wide surfaces, and the two second fork pieces clamp the two first wide surfaces.

In one embodiment, the first fork piece has a first contact protrusion facing towards the first gap; the second fork piece has a second contact protrusion facing towards the second gap; when the first differential signal terminal pair and the second differential signal terminal pair are mated, the first contact protrusion presses against the two first wide surfaces, and the second contact protrusion presses against the two first wide surfaces.

In one embodiment, both of the first body portion and the second body portion are plate-like and have a rectangular cross section.

To achieve the aforementioned objects, the present invention also adopts the following technical solutions:

The present invention provides a high-speed connector assembly, comprising the differential signal terminal pair as mentioned above.

In one embodiment, the high-speed connector assembly comprises a first high-speed connector and a second high-speed connector; the first high-speed connector comprises a plurality of the first differential signal terminal pairs; and the second high-speed connector comprises a plurality of the second differential signal terminal pairs.

In comparison with the prior art, the high-speed connector assembly of the present invention shortens the engaging length between terminals by improving the engaging structure of the first differential signal terminal pair and the second differential signal terminal pair, thereby achieving the purpose of eliminating stub. Therefore, the high-speed connector assembly of the present invention can maintain the highest frequency of the bandwidth to 60 GHz during signal transmission. At the same time, the differential signal terminal pair of the present invention adopts a criss-crossed mating or engaging type, which can also provide a more stable electrical contact, so as to further improve the mechanical performance and electrical connection performance of the high-speed connector assembly, therefore the present invention can be used in a high-density and high-speed transmission environment to meet high-density and high-speed signal transmission requirements.

### BRIEF DESCRIPTION OF THE DRAWINGS

FIG. 1 is a perspective schematic view of a first high-speed signal terminal of the present invention, and specifically shows a first differential signal terminal pair.

FIG. 2 is a perspective schematic view of a second high-speed signal terminal of the present invention, and specifically shows a second differential signal terminal pair.

FIG. 3 is a schematic view showing a position relationship of a differential signal terminal pair of the present invention before mating.

FIG. 4 is a schematic view showing a position relationship of a differential signal terminal pair of the present invention after mating.

FIG. 5 is another perspective view showing the differential signal terminal pair of the present invention after mating.

FIG. 6 is a schematic view of a first high-speed connector of a high-speed connector assembly of the present invention.

FIG. 7 is a schematic view of a second high-speed connector of a high-speed connector assembly of the present invention.

FIG. 8 is a schematic view of a high-speed connector assembly of the present invention, which mainly shows the state after a first high-speed connector mating with a second high-speed connector.

The reference numbers in the above drawings are explained as follows:
differential signal terminal pair 1
first differential signal terminal pair 10
first high-speed signal terminals 10a, 10b
first body portion 11
first wide surfaces 110
first narrow edges 111
first U-shaped fork end 12
first fork pieces 120
first gap 121
first contact protrusions 122
first tail end 13
first connecting portion 14
second differential signal terminal pair 20
second high-speed signal terminals 20a, 20b
second body portion 21
second wide surfaces 210
second narrow edges 211
second U-shaped fork end 22
second fork pieces 220
second gap 221
second contact protrusions 222
second tail end 23
second connecting portion 24
high-speed connector assembly 3
first high-speed connector 100
first insulating base 101
first shielding members 102
second high-speed connectors 200
second insulating base 201
second shielding members 202

### DETAILED DESCRIPTION OF THE EMBODIMENTS

The following description of every embodiment with reference to the accompanying drawings is used to exemplify a specific embodiment, which may be carried out according to the present invention. Directional terms mentioned in the present invention, such as “up”, “down”, “front”, “rear”, “left”, “right”, “top”, “bottom” etc., are only used with reference to the orientation of the accompanying drawings. Therefore, the used directional terms are intended to illustrate, but not to limit, the present invention.

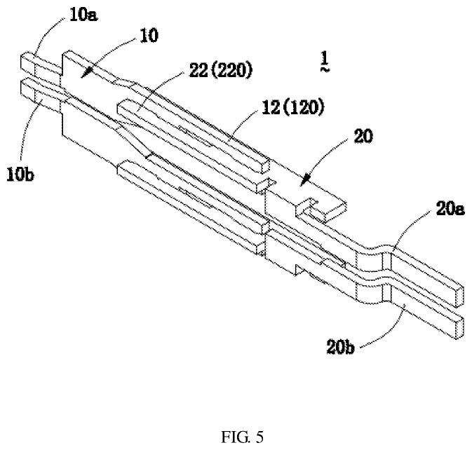

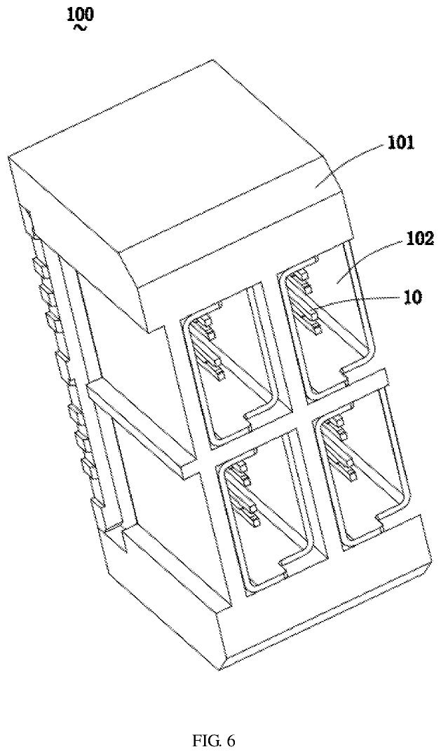

Please refer to FIGS. 1 to 5, a differential signal terminal pair 1 of the present invention comprises a first differential signal terminal pair 10 and a second differential signal terminal pair 20. The first differential signal terminal pair 10 includes two first high-speed signal terminals 10a, 10b, and the two first high-speed signal terminals 10a, 10b are edge-coupled. The second differential signal terminal pair 20 includes two second high-speed signal terminals 20a, 20b, and the two second high-speed signal terminals 20a, 20b are broad-coupled. The first differential signal terminal pair 10 and the second differential signal terminal pair 20 can be engaged to form an electrical connection. When engaging, a criss-cross (or quasi-star) mating structure is formed, thereby shortening the engaging length and eliminating stub.

As shown in FIG. 1, each first high-speed signal terminal 10a (10b) has a first body portion 11, a first U-shaped fork end 12, and a first tail end 13.

The first body portion 11 has two opposite first wide surfaces 110 and two opposite first narrow edges 111. In this embodiment, the first body portion 11 is plate-like and has a rectangular cross section.

The first U-shaped fork end 12 is located at the front end of the first body portion 11 and coplanar with the first body portion 11. In this embodiment, the first U-shaped fork end 12 has two first fork pieces 120 which are symmetrically arranged and coplanar, and a first gap 121 between the two first fork pieces 120, wherein the first fork piece 120 has a first contact protrusion 122 positioned toward the first gap 121.

The first tail end 13 is located at the rear end of the first body portion 11, and the first tail end 13 is connected to the first body portion 11 via a first connecting portion 14. The first connecting portion 14 can be bent slightly so as to make the first tail end 13 and the first body portion 11 staggered, and the first tail end 13 is parallel to the first U-shaped fork end 12 and the first body portion 11. As shown in FIG. 1, the first body portion 11 is placed vertically, and the first tail end 13 is also placed vertically, and the first body portion 11 and the first tail end 13 are parallel to each other. In other embodiments, the first tail end 13 can be formed directly at the rear end of the first body portion 11 without the first connecting portion 14, and coplanar with the first U-shaped fork end 12 and the first body portion 11.

More specifically, the first high-speed signal terminal 10a (10b) is stamped to form a one-piece structure, wherein the first U-shaped fork end 12 is coplanar with the first body portion 11. The first tail end 13 is parallel to the first U-shaped fork end 12 and the first body portion 11.

In this embodiment, as shown in FIG. 1, two first high-speed signal terminals 10a, 10b are edge-coupled, i.e., the first body portions 11 of the two first high-speed signal terminals 10a, 10b which form the first differential signal terminal pair 10 are arranged in a narrow edge to a narrow edge manner. Therefore, the first body portions 11 of the two first high-speed signal terminals 10a, 10b are coplanar. Similarly, the first U-shaped forks 12 of the two first high-speed signal terminals 10a and 10b are also arranged in a narrow-edge to narrow-edge manner and are coplanar. In this embodiment, the two first high-speed signal terminals 10a, 10b which form the first differential signal terminal pair 10 are symmetrical in structure. However, in other embodiments, the two first high-speed signal terminals 10a, 10b can have the same or different structure.

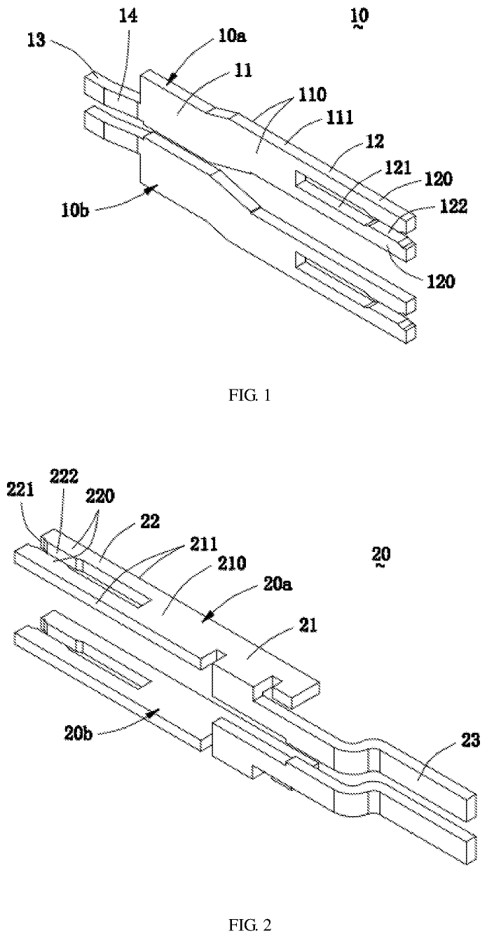

As shown in FIG. 2, each second high-speed signal terminal 20a (20b) has a second body portion 21, a second U-shaped fork end 22, and a second tail end 23.

The second body portion 21 is plate-like, and has two opposite second wide surfaces 210 and two opposite second narrow edges 211.

The second U-shaped fork end 22 is located at the front end of the second body portion 21 and coplanar with the second body portion 21. In this embodiment, the second U-shaped fork end 22 has two second fork pieces 220 which are symmetrically arranged and coplanar, and a second gap 221 between the two second fork pieces 220, wherein the second fork piece 220 has a second contact protrusion 222 positioned toward the second gap 221.

The second tail end 23 is located at the rear end of the second body portion 21, and is perpendicular to the second body portion 21. Specifically, the second tail end 23 is connected to the second body portion 21 via a second connecting portion 24. The second connecting portion 24 is connected to one of the second narrow edges 211 of the second body portion 21. Specifically, the second connecting portion 24 is formed by vertically bending one of the second narrow edges 211 of the second body portion 21, so that the second tail end 23 is perpendicular to the second body portion 21. As shown in FIG. 2, the second tail end 23 is placed vertically, while the second body portion 21 is placed horizontally, therefore the two are perpendicular to each other.

Further, the second high-speed signal terminal 20a (20b) is stamped to form a one-piece structure, wherein the second U-shaped fork end 22 is coplanar with the second body portion 21. The second tail end 23 is perpendicular to the second U-shaped fork end 22 and the second body portion 21.

In this embodiment, as shown in FIG. 2, two second high-speed signal terminals 20a, 20b are broad-coupled, i.e., the second body portions 21 of the two second high-speed signal terminals 20a, 20b which form the second differential signal terminal pair 20 are arranged in a wide surface to wide surface manner. Therefore, the second body portions 21 of the two second high-speed signal terminals 20a, 20b are arranged in parallel. Similarly, the second U-shaped fork ends 22 of the two second high-speed signal terminals 20a, 20b are also arranged parallelly in a wide surface to wide surface manner.

In this embodiment, the two second high-speed signal terminals 20a, 20b forming the second differential signal terminal pair 20 have a symmetrical structure. For example, the second connecting portion 24 of one second high-speed signal terminal 20a is formed by bending downward, and the second connecting portion 24 of the other second high-speed signal terminal 20b is formed by bending upward. However, in other embodiments, the two second high-speed signal terminals 20a, 20b can have the same or different structure.

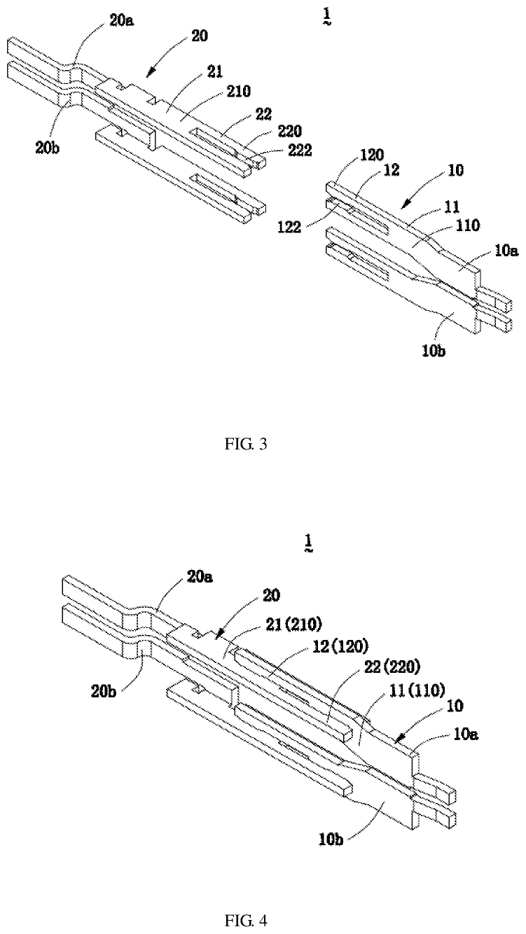

As shown in FIGS. 3, 4, and 5, when the first differential signal terminal pair 10 and the second differential signal terminal pair 20 are mated, the first body portion 11 and the first U-shaped fork end 12 of the first high-speed signal terminal 10a are perpendicular to the second body portion 21 and the second U-shaped fork end 22 of the second high-speed signal terminal 20a, as well as the first U-shaped fork end 12 and the second U-shaped fork end 22 are inserted into each other to form an electrical connection. Specifically, the two first fork pieces 120 of the first U-shaped fork end 12 clamp the two second wide surfaces 210 of the second body portion 21, and press against the two opposite second wide surfaces 210 via the first contact protrusions 122 to form an electrical contact or electrical connection; while the two second fork pieces 220 of the second U-shaped fork end 22 will clamp the two first wide surfaces 110 of the first body portion 11 and press against the two first wide surfaces 110 via the second contact protrusions 222 to form an electrical contact or electrical connection.

It can be seen that after the first differential signal terminal pair 10 and the second differential signal terminal pair 20 are mated, the first high-speed signal terminal 10a (10b) and the second high-speed signal terminal 20a (20b) form a criss-crossed mating structure (or in a quasi-star structure), and especially the first U-shaped fork end 12 and the second U-shaped fork end 22 form a criss-crossed mating or engagement, so as to shorten the engaging length between the first high-speed signal terminal 10a (10b) and the second high-speed signal terminal 20a (20b) and eliminate stub.

In addition, after the first differential signal terminal pair 10 and the second differential signal terminal pair 20 are mated, the first tail end 13 and the second tail end 23 are coplanar. Of course, the first tail end 13 can be parallel to the second tail end 23 according to pin arrangement.

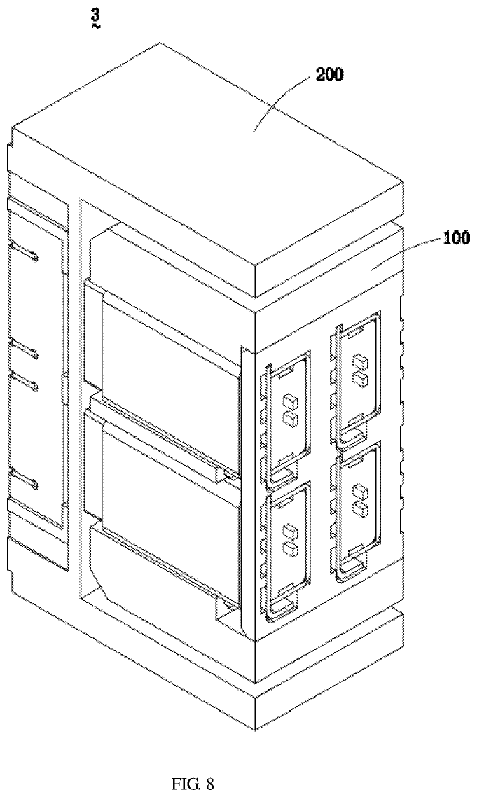

It should be noted that the present invention does not limit the size of the first high-speed signal terminal 10a (10b), i.e., the length or width of the first body portion 11, the first U-shaped fork end 12, and the first tail end 13 can be adjusted according to the size of the actual connector. In particular, the length of the first tail end 13 can be as long as possible to extend out of the mounting surface of the first insulating base 101 of the first high-speed connector 100 as shown in FIGS. 6 and 8, so that the first tail end 13 can be connected or soldered to an external circuit board. For example, in FIG. 8, the dotted line shows the scenario where the first tail end 13 is extended out of the mounting surface of the first insulating base 101.

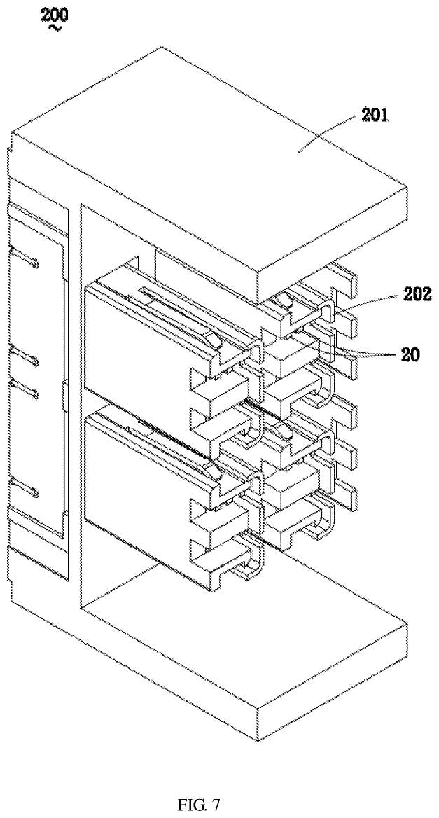

Similarly, the present invention does not limit the size of the second high-speed signal terminals 20a, 20b, i.e., the length or width of the second body portion 21, the second U-shaped fork end 22, and the second tail end 23 can be adjusted according to the size of the actual connector. In particular, the length of the second tail end 23 can be as long as possible to extend out of the mounting surface of the second insulating base 201 of the second high-speed connector 200 as shown in FIGS. 7 and 8, so that the second tail end 23 can be connected or soldered to an external circuit board.

Please refer to FIGS. 6 to 8, the present invention also provides a high-speed connector assembly 3 which includes a first high-speed connector 100 as shown in FIG. 6 and a second high-speed connector 200 as shown in FIG. 7.

As shown in FIG. 6, the first high-speed connector 100 includes a first insulating base 101, a plurality of first shielding members 102 fixed on the first insulating base 101, and a plurality of first differential signal terminal pair 10 fixed on the first insulating bases 101. The first shielding members 102 surround the corresponding first differential signal terminal pairs 10. The surrounding as described here can be half-surrounding.

As shown in FIG. 7, the second high-speed connector 200 includes a second insulating base 201, a plurality of second shielding members 202 fixed on the second insulating base 201, and a plurality of second differential signal terminal pair 20 fixed on the second insulating bases 201. The second shielding members 202 surround the corresponding second differential signal terminal pairs 20. Similarly, the surrounding as described here can be half-surrounding.

Please refer to FIG. 8, when the first high-speed connector 100 is engaged with the second high-speed connector 200, the first shielding member 102 and the second shielding member 202 surround the engaged differential signal terminal pair 1 together. The first differential signal terminal pair 10 and the second differential signal terminal pair 20 form a criss-crossed mating or engagement, so as to provide an electrical connection for the first high-speed connector 100 and the second high-speed connector 200, and since the present invention can shorten the engaging length between the first differential signal terminal pair 10 and the second differential signal terminal pair 20, the purpose of eliminating stub can be achieved.

In summary, the high-speed connector assembly 3 of the present invention improves the engaging structure of the first differential signal terminal pair 10 and the second differential signal terminal pair 20, thereby shortening the engaging length between the terminals, and achieving the purpose of eliminating stub. Therefore, the high-speed connector assembly 3 of the present invention can maintain the highest frequency of the bandwidth to 60 GHz during signal transmission. At the same time, the differential signal terminal pair of the present invention adopts a criss-crossed mating or engaging type, which can also provide a more stable electrical contact, so as to further improve the mechanical performance and electrical connection performance of the high-speed connector assembly 3, so that the present invention can be applied in a high-density and high-speed transmission environment and meet high-density and high-speed signal transmission requirement.

1. A high-speed signal terminal, comprising:
a body portion having two opposite wide surfaces and two opposite narrow edges;
a U-shaped fork end being located at a front end of the body portion and being coplanar with the body portion; wherein the U-shaped fork end has two symmetrical and coplanar fork pieces, and a gap located between the two fork pieces; and
a tail end being located at a rear end of the body portion.

2. The high-speed signal terminal as claimed in claim 1, wherein the body portion is plate-like and has a rectangular cross section.

3. The high-speed signal terminal as claimed in claim 1, wherein each of the fork pieces has a contact protrusion facing towards the gap.

4. The high-speed signal terminal as claimed in claim 1, wherein the tail end and the body portion are staggered each other, and the tail end is parallel to the U-shaped fork end and the body portion.

5. The high-speed signal terminal as claimed in claim 1, wherein the tail end is perpendicular to the U-shaped fork end and the body portion.

6. A differential signal terminal pair, comprising a first differential signal terminal pair and a second differential signal terminal pair, and the first differential signal terminal pair comprising two first high-speed signal terminals, and the second differential signal terminal pair comprising two second high-speed signal terminals;
wherein, the two first high-speed signal terminals are edge-coupled, and each first high-speed signal terminal comprises: a first body portion, a first U-shaped fork end, and a first tail end; wherein, the first body portion has two opposite first wide surfaces and two opposite first narrow edges; the first U-shaped fork end is located at a front end of the first body portion and is coplanar with the first body portion, and the U-shaped fork end has two first fork pieces which are symmetrical and coplanar, and a first gap between the two first fork pieces; the first tail end is located at a rear end of the first body portion; and
wherein, the two second high-speed signal terminals are broad-coupled, and each second high-speed signal terminal comprises: a second body portion, a second U-shaped fork end, and a second tail end; wherein, the second body portion has two opposite second wide surfaces and two opposite second narrow edges; and the second U-shaped fork end is located at a front end of the second body portion and is coplanar with the second body portion, and the second U-shaped fork ends have two second fork pieces which are symmetrical and coplanar, and a second gap between the two second fork pieces; and the second tail end is located at a rear end of the second body portion;
when the first differential signal terminal pair and the second differential signal terminal pair are mated, the first high-speed signal terminal and the corresponding second high-speed signal terminal are engaged in a criss-crossed manner, wherein the first body portion and the first U-shaped fork end are perpendicular to the second body portion and the second U-shaped fork end, the two first fork pieces clamp the two second wide surfaces, and the two second fork pieces clamp the two first wide surfaces.

7. The differential signal terminal pair as claimed in claim 6, wherein
the first fork piece has a first contact protrusion facing towards the first gap;
the second fork piece has a second contact protrusion facing towards the second gap;
when the first differential signal terminal pair and the second differential signal terminal pair are mated, the first contact protrusion presses against the two first wide surfaces, and the second contact protrusion presses against the two first wide surfaces.

8. The differential signal terminal pair as claimed in claim 6, wherein both of the first body portion and the second body portion are plate-like and have a rectangular cross section.

9. A high-speed connector assembly, comprising the differential signal terminal pair as claimed in claim 6.

10. The high-speed connector assembly as claimed in claim 9, wherein the high-speed connector assembly comprises a first high-speed connector and a second high-speed connector;
the first high-speed connector comprises a plurality of the first differential signal terminal pairs; and
the second high-speed connector comprises a plurality of the second differential signal terminal pairs.
